(19) United States
(12) Patent Application Publication
(10) Pub. No.: US 2002/0084661 A1
(43) Pub. Date: Jul. 4, 2002

(54) Below floor travel tilt retractable room support

(76) Inventors: Patrick W. McManus, Osceola, IN (US); Martin P. McManus, Mishawaka, IN (US)

Correspondence Address: BAKER & DANIELS, 205 W. JEFFERSON BOULEVARD, SUITE 250, SOUTH BEND, IN, 46601, US

(21) Appl. No.: 10/010,640

(22) Filed: Nov. 13, 2001

Related U.S. Application Data
(60) Provisional application No. 60/247,113, filed on Nov. 10, 2000.

(51) Int. Cl. B60P 3/35

(52) U.S. Cl. 296/26.01; 296/26.14

(57) ABSTRACT

A drive mechanism is shown for transportable living quarters. An outer tube is oriented so that the corresponding inner tube extends downwardly relative to the main living area, lowering the slide-out room back wall and causing the slide-out room to tilt slightly outward in its extended position to compress an inner compressible seal between sealing surfaces on the main living area and the slide-out room inner flange. Similarly, upon retraction, the back wall is raised relative to the main living area, tilting the room in the opposite direction to compress an outer compressible seal between sealing surfaces on the outside of the main living area and the outer flange of the slide-out room. The mechanism may include an adjustment mechanism to adjust the angle of the outer tube for optimal sealing. The mechanism may also be used in conjunction with a wear bar attached to the edge of the main living area floor to increase the tilt applied to the slide-out room for added pressure on the compressible seals.

### FIELD OF THE INVENTION

This invention relates generally to slide-out rooms for use with recreational vehicles and more particularly to an actuation mechanism that tilts the slide-out room as it moves the room into its extended and retracted positions to achieve a tight seal along the upper flanges of the room.

### BACKGROUND OF THE INVENTION

The widths of transportable living quarters such as recreational vehicles are limited to that which may be accommodated for travel on roads. Accordingly, it is increasingly common to provide recreational vehicles with slide-out rooms that can be retracted into the main living area when the vehicle is being driven, and extended from the main living area to provide auxiliary living space when the unit is parked for use.

Typically, slide-out rooms are supported by telescoping tubes or other actuation mechanisms mounted to the frame of the vehicle. The actuation mechanisms are usually connected to a lower portion of the slide-out room and extended laterally from the vehicle to move the room to its extended position to increase the living space of the vehicle. When the actuation mechanisms are retracted, the slide-out room is likewise retracted into the main living area of the vehicle. Sealing is provided around the perimeter of the room to seal the room in both the extended and retracted positions. However, the slide-out room is only semi-rigid, and portions of the room farthest from the actuation mechanisms (normally the top edge of the room) may not receive sufficient inward force from the actuation mechanisms to ensure proper sealing. Some actuation mechanisms can be adjusted so that the portions of the room closest to the actuation mechanisms (normally the portion of the room closest to the frame and floor) are maintained against the seals when the room is retracted. Again, however, the portion of the room farthest away from the actuation mechanisms adjacent the ceiling may deflect sufficiently that the seals are not engaged, thereby permitting dust and water to enter the main living area during travel.

Accordingly, it has become customary to use so-called “travel locks” to latch and maintain the top of the slide-out room in a position in which the upper flange of the slide-out room is engaged with and sealed against the main living area. Such latching mechanisms are generally positioned on the inside of the vehicle along the side wall opening which receives the room. When the room is retracted into the vehicle, the latching mechanisms are engaged to lock the room against the side wall of the vehicle such that the room outer wall is compressed against the vehicle side wall along the periphery of the side wall opening to provide the desired seal. These latching mechanisms, however, are cumbersome and inconvenient to operate.

Moreover, since the latching mechanisms are manual, the vehicle operator must remember to lock the room into its retracted position before travel, and to unlock the latching mechanisms before extending the room to its in-use position. If the latching mechanisms are not engaged during travel, the elements may enter the main living area of the vehicle causing damage. If the latching mechanisms are not disengaged before the operator attempts to extend the slide-out room to its in-use position, the actuation mechanisms, the slide-out room, or other components of the vehicle may be seriously damaged.

To further complicate matters, any device used to lock the room in its retracted position cannot interfere with the peripheral seal between the slide-out room and the vehicle side wall. A bulb seal or other sealing structure is generally mounted to the peripheral flange of the room or the side wall of the vehicle and compressed between the flange and the side wall when the room is in its retracted position. Additionally, wiper seals or other such weather stripping are typically mounted along the edges of the vehicle side wall opening. These seals wipe along the side walls and ceiling of the room to remove moisture as the room is retracted into the main living area of the vehicle. Accordingly, it is desirable to provide a mechanism to improve sealing, particularly along the top of the slide-out room, that does not interfere with these existing sealing methods.

### SUMMARY OF THE INVENTION

The present invention provides an extension and retraction mechanism for a slide-out room that includes an outer tube attached to the frame of the vehicle below the main living area floor and an inner tube slidable within the outer tube which is attached to the slide-out room. The outer tube is mounted at a downward angle so that the inner tube extends likewise at a downward angle and retracts at a similar upward angle. The slide-out room assembly includes compressible seals to seal the main and auxiliary living areas. The downward extension and upward retraction of the inner tube and the slide-out room attached thereto cause the slide-out room to tilt when moved into its extended and retracted positions, thereby compressing the seals and producing a tighter seal between the main living area and the slide-out room.

In another embodiment of the invention, an adjustment mechanism is provided for adjusting the angle of the outer tube to ensure adequate compression of the seals.

In yet another version of the invention, the main living area room is provided with a wear bar along the lower edge of the vehicle side wall opening over which the slide-out room travels to increase the tilt of the slide-out room when in the extended and retracted positions. Preferably, the floor of the slide-out room tilts slightly downwardly, so as to cause a rotation of the room about the wear bar, when in both the fully extended and fully retracted positions. In this manner, the seal is adequately compressed to provide a proper seal.

These and other advantages of the present invention will become apparent from the following description, with reference to the accompanying drawings.

### BRIEF DESCRIPTION OF THE DRAWINGS

FIG. 1 is a perspective view of a recreation vehicle having a slide-out room in the extended position;

FIG. 2 is a cross-sectional view of a recreation vehicle having a slide-out room with a tilt mechanism according to one embodiment of the present invention, the slide-out room being shown in its retracted position;

FIG. 3 is a cross-sectional view of the recreation vehicle of FIG. 2 with the slide-out room being shown in its extended position;

FIG. 4 is a cross-sectional view of a recreation vehicle having a slide-out room with another embodiment of a tilt mechanism according to the present invention, the slide-out room being shown in its retracted position;

FIG. 5 is a cross-sectional view of the recreation vehicle of FIG. 4 with the slide-out room being shown in its extended position;

FIG. 6 is a cross-sectional view of a recreation vehicle having a slide-out room with another embodiment of a tilt mechanism according to the present invention, the slide-out room being shown in its retracted position;

FIG. 7 is a cross-sectional view of the recreation vehicle of FIG. 6 with the slide-out room being shown in its extended position;

FIG. 8 is a cross-sectional view of a recreation vehicle having a slide-out room with another embodiment of a tilt mechanism according to the present invention, the slide-out room being shown in its retracted position; and

FIG. 9 is a cross-sectional view of the recreation vehicle of FIG. 8 with the slide-out room being shown in its extended position;

### DETAILED DESCRIPTION OF EMBODIMENTS OF THE INVENTION

For the purposes of promoting an understanding of the principles of the invention, reference will now be made to the embodiments illustrated in the drawings and specific language will be used to describe the same. It will nevertheless be understood that no limitation of the scope of the invention is thereby intended. The invention includes any alterations and further modifications to the illustrated embodiments and described methods and further applications of the principles of the invention which would normally occur to one skilled in the art to which the invention relates.

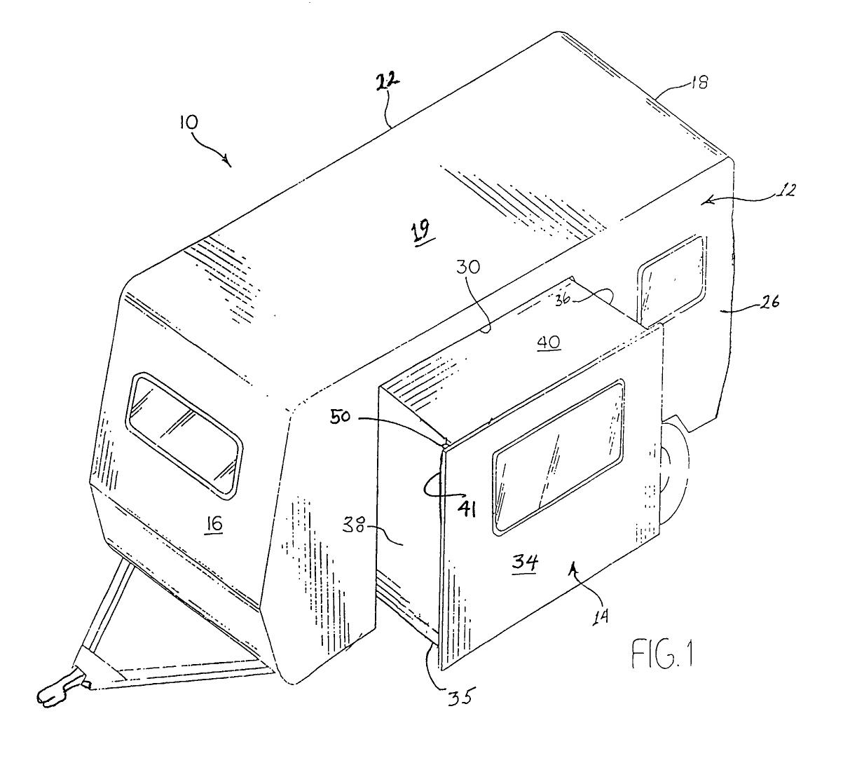

Referring to FIG. 1 of the drawings, mobile living quarters, such as a recreational vehicle, is generally indicated by the numeral 10. The vehicle 10 includes a main living area generally indicated by the numeral 12 and an auxiliary living area or slide-out room generally indicated by the numeral 14. Main living area 12 further includes a ceiling 19, a side wall 22, a pair of end walls 16 and 18, and a side wall 26 opposite side wall 22, a portion of which is cut away to define an opening 30 through which slide-out room 14 extends and retracts.

With reference still to FIG. 1, slide-out room 14 generally includes a back wall 34, a pair of side walls 36 and 38, a ceiling 40, and a floor 35. Side walls 36 and 38, ceiling 40, and floor 35 define the auxiliary living space which is open to main living area 12.

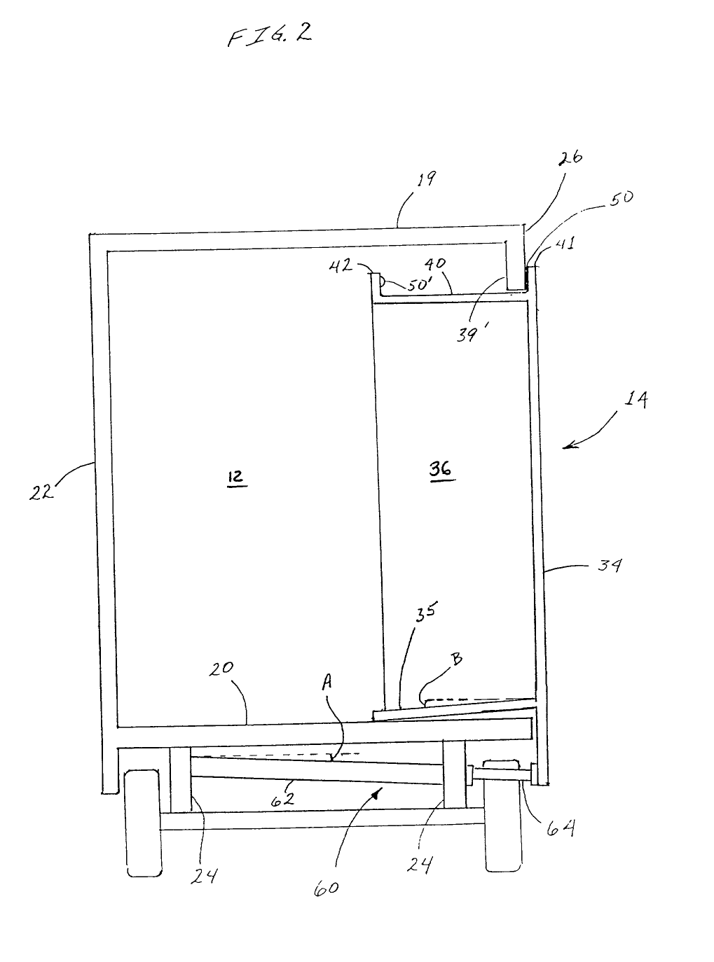

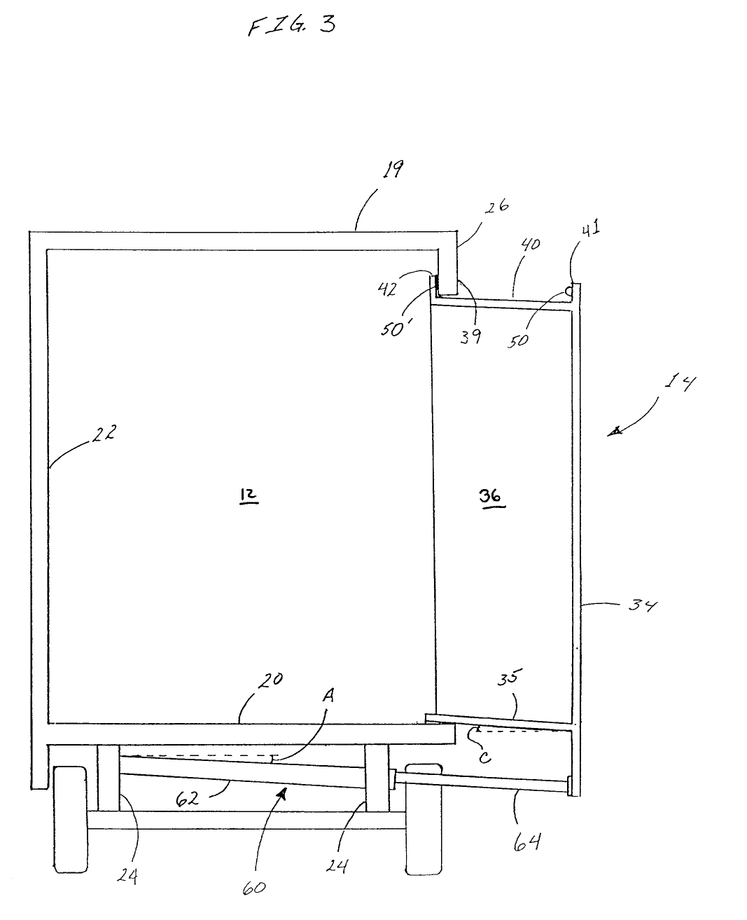

Side cross-sectional views of recreational vehicle 10 are depicted in FIG. 2, with slide-out room 14 retracted, and FIG. 3, with slide-out room 14 extended. Back wall 34 includes a flange 41 which extends vertically beyond ceiling 40 and floor 35 and horizontally beyond side wall 36, 38. Flange 41 carries compressible seal 50 to seal slide-out room 14 against vehicle or main living area wall 26 when room 14 is retracted. Likewise, a flange 42 extends vertically beyond ceiling 40 and horizontally beyond side walls 36, 38 at the interior end of room 14. Flange 42 also carries a compressible seal 50′ for seating room 14 in its extended position. Seals 50 and 50′ are the exterior and interior seals, respectively. Seals 50, 50′ engage corresponding sealing surfaces 39 and 39′ on side wall 26 of vehicle 10. Seals 50, 50′ could be attached to surfaces 39 and 39′ if desired with equally effective results.

Actuation or drive mechanism 60 is located below vehicle floor 20 and can be mounted on the longitudinally extending frame or support members 24 supporting floor 20 of main living area 12. Support members 24 can take any of several forms commonly known in the art. Additionally, more than one drive mechanism 60 may be used, depending upon the size of room 14. It should be understood that drive mechanism 60 includes a hydraulic piston or ram (not shown) or other device for extending and retracting mechanism 60. Drive mechanism 60 also includes an outer tube 62 attached to longitudinal support members 24 and an inner tube 64 telescopically received by outer tube 62 and attached to back wall 34 of room 14. Outer tube 62 is mounted at a downward angle “A” relative to horizontal. The positioning angles in the drawings are somewhat exaggerated to aid in the understanding of the invention.

In operation, the angular installation of outer tube 62 of drive mechanism 60 causes back wall 34 of slide-out room 14 to be raised and lowered slightly as slide-out room 14 is retracted and extended. Furthermore, the angular orientation of the floor is as shown in FIG. 2, as angle B. As shown in FIG. 2, in the retracted position, back wall 34 is raised slightly resulting in the angular relationship of slide-out room floor 35 to main living area floor 20 as shown. This lifting of back wall 34 produces a slight inward tilt in slide-out room 14, thereby increasing the pressure on upper seal 50 and resulting in a tighter seal at the top of slide-out room 14.

Referring now to FIG. 3, as slide-out room 14 is extended, inner tube 64 of drive mechanism 60 lowers back wall 34 such that when room 14 is in the extended position, room floor 35 is angled slightly downward relative to main living area floor 20 as indicated by angle “C.” This lowering of back wall 34 results in a slight outward tilt which increases the pressure on inner seal 50′, thereby producing a tighter seal along flange 42.

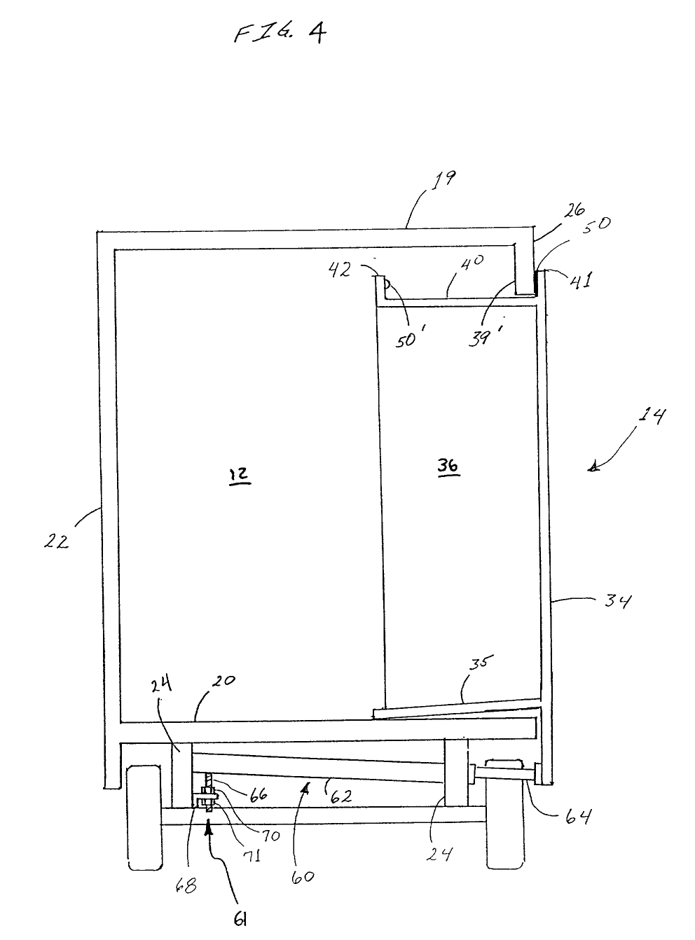

In another embodiment of the invention, drive mechanism 60 includes an adjustment mechanism 61 as shown in FIG. 4. Adjustment mechanism 61 includes a threaded rod 66 which abuts outer tube 62 and passes through an opening (not shown) in a bracket 68 attached to frame support member 24. An upper nut 70 may be rotated on rod 66 to raise or lower rod 66 relative to bracket 68, thereby adjusting the angle of outer tube 62. A lower nut 71 is tightened against bracket 68 when nut 70 is positioned to lock the position of adjustment mechanism 61. Using adjustment mechanism 61, the user or a technician can adjust the angle of outer tube 62 and thereby adjust the amount of tilt experienced by slide-out room 14 to achieve the desired amount of seal compression on seals 50 and 50′.

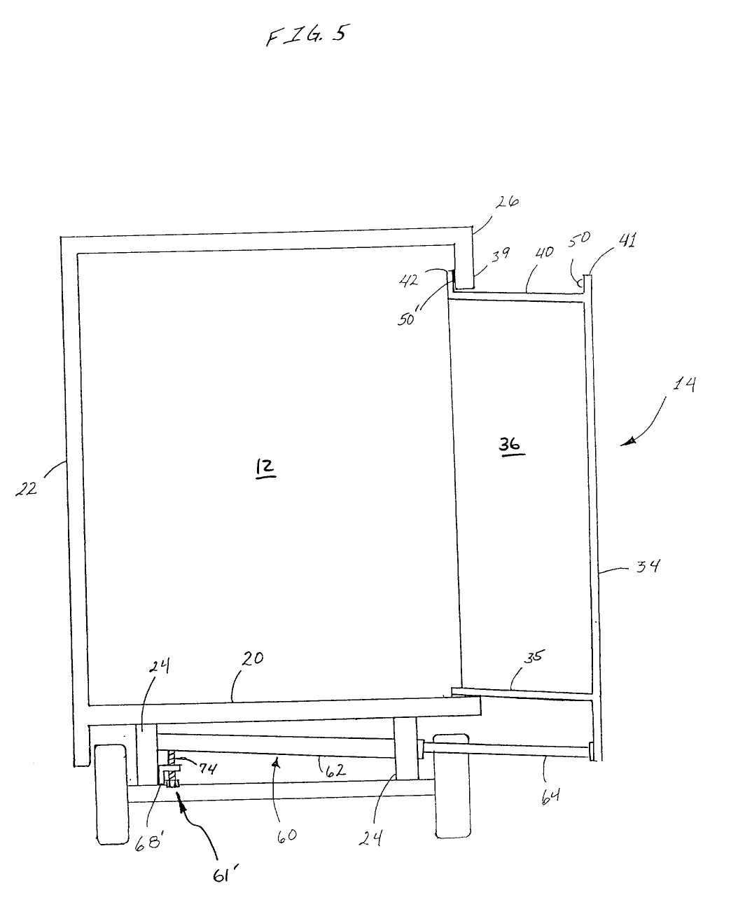

In an alternate embodiment of an adjustment mechanism 61′ (FIG. 5), bracket 68′ includes a threaded opening (not shown) which receives a bolt 74 that screws up against outer tube 62 to adjust the angle of outer tube 62 as described above.

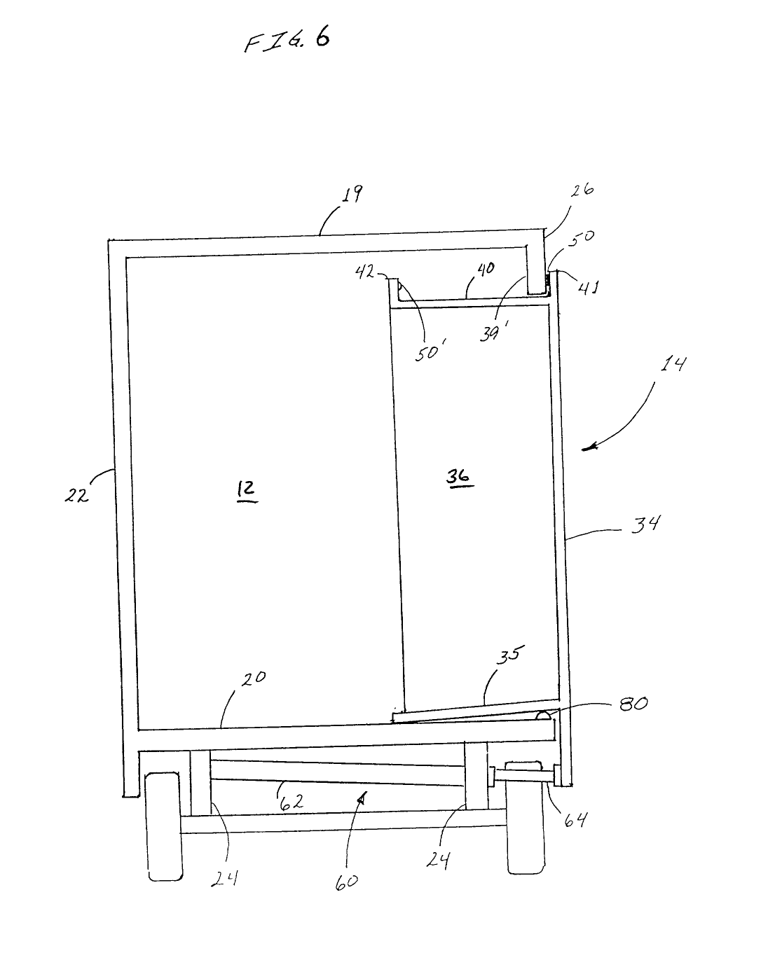

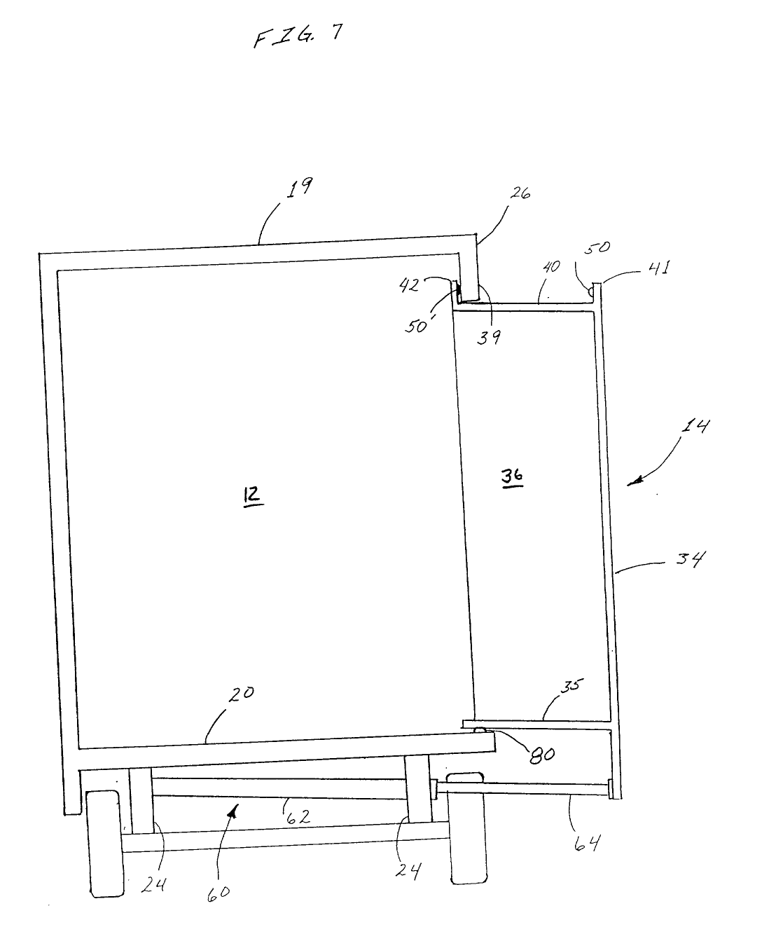

In another embodiment of the invention shown in FIGS. 6 and 7, the outer edge of main living area floor 20 adjacent side wall 26 includes a wear bar 80 which may extend along the width of slide-out room opening 30. Alternatively, multiple segments of wear bar 80 may be used. Wear bar 80 provides a fulcrum such that floor 35 of room 14 pivots over wear bar 80 during movement between the extended and retracted positions. When room 14 is in either the extended or retracted position, wear bar 80 increases the tilt of slide-out room 14, thus increasing the pressure on seals 50 and 50′ and providing a tighter seal at the upper portion of room 14.

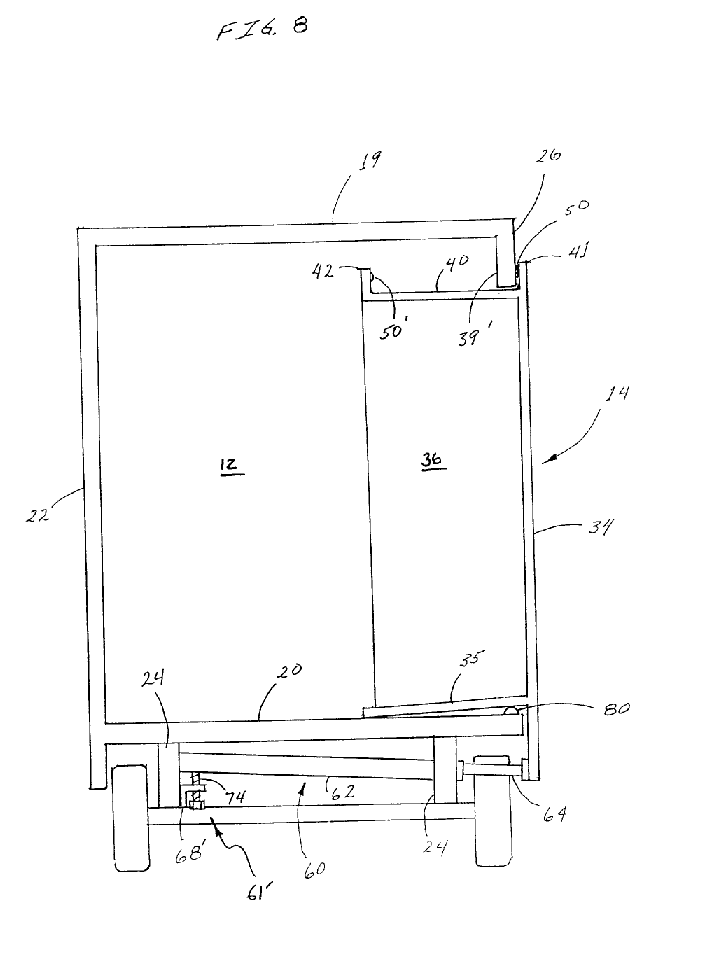

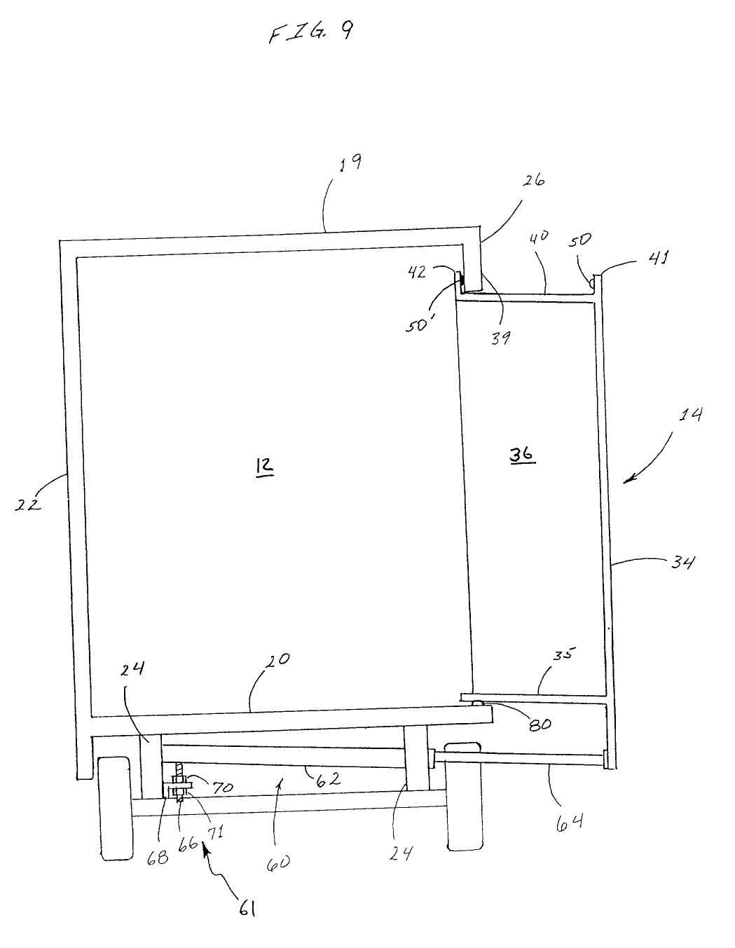

The adjustment mechanism and wear bar features can be used in combination as depicted in FIGS. 8 and 9. FIG. 8 shows slide-out room 14 in the retracted position and with adjustment mechanism 61′ of FIG. 5. FIG. 9 shows slide-out room 14 in the extended position and with adjustment mechanism 61 of FIG. 4.

In a preferred embodiment, inner and outer tubes 62, 64 are made of a material such as steel. Inner tube 64 is welded or bolted to back wall 34 of room 14. Typically, such a welded or bolted connection is sufficiently flexible to withstand the flexing experienced at the point of attachment of inner tube 64 to back wall 34. Alternatively, a pivot pin connection could be used.

While the invention has been illustrated and described in detail in the drawings and foregoing description, the same is to be considered as illustrative and not restrictive in character. It should be understood that only exemplary embodiments have been shown and described, and that all changes and modifications that come within the spirit of the invention and the scope of the appended claims are desired to be protected.

What is claimed is:

1. For transportable living quarters having a main living area and a slide-out room assembly movable relative to said main living area between a retracted position retracted within the main living area and an extended position extended from the main living area to provide an auxiliary living area, the slide-out room having a back wall and a floor which is movable over a floor of the main living area, a mechanism for extending and retracting the slide-out room, said mechanism including:
a seal between the slide-out room and the main living area to seal the main and auxiliary living areas; and
a drive mechanism attached below the main living area floor and interconnecting the slide-out room and the main living area for moving the slide-out room between the retracted and extended positions
wherein said drive mechanism is configured so that the slide-out room back wall descends during extension and rises during retraction thereby tilting the slide-out room relative to the main living area as the slide-out room moves into the extended and retracted positions to thereby compress said seal.

2. The mechanism of claim 1 wherein the slide-out room back wall includes a peripheral outer flange defining a sealing surface, said seal including an outer seal disposed between said sealing surface of said outer flange and a corresponding sealing surface on said main living area so that said outer seal is compressed when said slide-out room moves into said retracted position.

3. The mechanism of claim 1 wherein said slide-out room includes a ceiling and a pair of opposite side walls, said ceiling and side walls defining an inner flange, said inner flange defining a sealing surface, said seal including an inner seal disposed between said sealing surface of said inner flange and a corresponding sealing surface of said main living area so that said inner seal is compressed when said slide-out room moves into said extended position.

4. The mechanism of claim 1 wherein said drive mechanism includes an outer tube mounted below the main living area floor and an inner tube slidable within said outer tube and connected to the slide-out room, said outer tube being mounted an angle so that said inner tube extends at a downward angle as it extends from said outer tube.

5. The mechanism of claim 4 wherein said drive mechanism further includes an adjustment mechanism attached to said main living area in engagement with said outer tube to adjust said angle of said outer tube to ensure adequate compression of said seal when the slide-out room is in the extended and retracted positions.

6. The mechanism of claim 1 wherein the main living area floor defines an outer edge and said mechanism further includes a wear bar attached to said outer edge of the main living area floor to increase the tilt of the slide-out room when the slide-out room is in the extended and retracted positions.
